(19) United States
(12) Patent Application Publication
(10) Pub. No.: US 2014/0172349 A1
(43) Pub. Date: Jun. 19, 2014

(54) Method and Apparatus for Determining a Process Variable

(71) Applicant: Endress + Hauser Wetzer GmbH + Co. KG, Nesselwang (DE)

(72) Inventor: Thomas Härle, Oy-Mittelberg (DE)

(73) Assignee: Endress + Hauser Wetzer GmbH + Co. KG, Nesselwang (DE)

(21) Appl. No.: 14/104,206

(22) Filed: Dec. 12, 2013

(30) Foreign Application Priority Data
Dec. 18, 2012 (DE) 10 2012 112 572.4
Jan. 4, 2013 (DE) 10 2013 100 045.2

(51) Int. Cl. G01K 19/00

(52) U.S. Cl. CPC G01K 19/00
USPC 702/130

(57) ABSTRACT

A method and apparatus for determining a process variable, of a primary sensor, wherein by means of the primary sensor an analog measurement signal is produced, which analog measurement signal is converted into a digital signal representing the measured variable, wherein by means of at least one secondary sensor at least one reference signal is produced, and wherein as a function of the point in time, at which the reaching of a predetermined state of the process variable, especially the reaching of a value of the reference signal.

The invention relates to a method as well as to an apparatus for determining a process variable.

Known from the state of the art are diverse methods and apparatuses for calibrating a thermometer. Thus, for example, known from WO 2012028387 A1 is an apparatus having a temperature sensor and a reference element, wherein the reference element experiences a phase transformation in the temperature range relevant for calibrating the temperature sensor.

Known, for example, from Offenlegungsschrift DE 102009050431 A1 and Patent DE 102004027072 B3, are, furthermore, other methods for calibrating temperature sensors, such as, for example, thermometers, temperature sensors and temperature measuring devices.

For validation, adjusting, calibrating and/or certification of such temperature sensor elements, the sensor, for example, to be calibrated, respectively its measurement signal, is compared with the measurement signal of a reference sensor. Based on this comparison, then an inference concerning the state, such as, for example, the drift or aging, of the primary sensor can be made.

It is, consequently, an object of the present invention to provide for highly accurate determining of a process variable.

The object is achieved according to the invention by a method for determining a process variable, as well as by a corresponding apparatus.

As regards the method, the object is achieved by a method for determining a process variable, which method serves especially for validation, adjusting, calibrating and/or certification of a primary sensor, wherein by means of the primary sensor an analog measurement signal representing a process variable is produced, which analog measurement signal is converted by means of an analog to digital converter into a digital signal representing the measured variable, wherein by means of at least one secondary sensor at least one reference signal is produced representing the process variable.

Especially, the reference signal can reflect a state of the process variable. For example, the state of the process variable can be reflected by a value of the reference signal. Especially, a reference signal can be provided that is discretely evaluatable, i.e. the reference signal represents a first, respectively a second, state of the process variable, which lies above, respectively below, a predetermined threshold value of the process variable.

As a function of the point in time, at which the reaching of a predetermined state of the process variable is displayed by the reference signal, the value of the measurement signal of the primary sensor converted by means of the analog to digital converter can be logged. The predetermined state of the process variable can, for example, be a value of the reference signal itself. This means, for example, that upon reaching a threshold value by the reference signal, the value of the measurement signal of the primary sensor converted by means of the analog to digital converter is logged.

Furthermore, as a function of the point in time, at which the reaching of a predetermined state of the process variable is displayed by the reference signal, the connection between the analog to digital converter and the primary sensor can be interrupted. While, thus, the preceding form of embodiment describes the logging of an analog measurement signal already converted by the analog to digital converter, according to the present form of embodiment, the connection, i.e. the connection between the input of the analog to digital converter and the primary sensor, is directly interrupted.

Furthermore, as a function of the point in time, at which the reaching of the predetermined state of the process variable is displayed by the reference signal, the sampling rate of the value of the measurement signal of the primary sensor converted by means of the analog to digital converter can be changed. In this way, for example, as a function of the reference signal, for example, for the purpose of highly accurate signal sampling, the sampling rate can be increased.

As a function of the point in time, at which the reaching of a predetermined state of the process variable is displayed by the reference signal, a processing, such as, for example, a measured value averaging of the analog measurement signal of the primary sensor converted by the analog to digital converter, can be changed in the evaluation unit.

In a form of embodiment of the method, the measurement signal of the primary sensor is a continuous measurement signal. Preferably, the measurement signal is continuous both with respect to time as well as also value.

This continuous measurement signal is converted by means of the analog to digital converter into a digital signal representing the measured variable.

In a form of embodiment of the method, the reference signal is an essentially discrete signal, preferably a value discrete signal, which is, however, continuous with respect to time. Preferably, the reference signal has, in such case, exactly two values, which it can assume.

In an additional form of embodiment of the method, a likewise analog signal representing the process variable is ascertained by means of the secondary sensor, wherein by means of a measurement transmitter, the process variable ascertained by means of the secondary sensor is converted into the reference signal. In the simplest case here, the measurement transmitter is also an analog to digital converter.

In an additional form of embodiment of the method, the measurement signal and the at least one reference signal are fed to a signal logging apparatus. The signal logging apparatus can be connected with the analog to digital converter and serve, for example, to operate the analog to digital converter, especially to select different operating modes of the analog to digital converter. For example, by means of the signal logging apparatus, the measurement signal of the primary sensor can be logged especially as a function of the point in time, at which the reaching of a predetermined state of the process variable is displayed by the reference signal.

Furthermore, the signal logging apparatus can also serve to interrupt the connection between the analog to digital converter and the primary sensor, especially as a function of the point in time, at which the reaching of a predetermined state of the primary variable is displayed by the reference signal. Furthermore, likewise the sampling rate of the value of the measurement signal of the primary sensor converted by means of the analog to digital converter can be changed.

Additionally, the signal logging apparatus can control the processing, especially a measured value averaging, in the evaluation unit. Used as trigger signal for triggering a corresponding function can be, for example, the reference signal. The reference signal can, for example, start the signal logging procedure. To this end, for example, a capacitor can be used, which serves as signal logging apparatus and by means of which the last analog measurement signal of the primary sensor present at interruption of the connection between the primary sensor and the analog to digital converter is logged.

In an additional form of embodiment of the method, by means of the signal logging apparatus, the connection to the primary sensor can be produced and/or interrupted, preferably as a function of the reference signal.

To this end, corresponding switching, respectively switching arrangements, can be provided, which switch as a function of the reference signal.

In an additional form of embodiment of the method, the digitized measurement signal representing the process variable is stored by means of an evaluation unit. This digitized measurement signal representing the process variable is, for example, tapped from the output of the analog to digital converter and fed to the evaluation unit.

In an additional form of embodiment of the method, the reaching of a predetermined state of the process variable is transmitted via a signal line between the at least one secondary sensor and the evaluation unit. Especially, in the case, in which a plurality of secondary sensors is provided, i.e. at least two, preferably three, and especially preferably four secondary sensors, it can be reported to the evaluation unit via the signal line concerning which of the secondary sensors displayed the reaching of the predetermined state of the process variable.

In an additional form of embodiment of the method, the transmission of the reference signal via the signal line occurs in addition to the transmission of the reference signal to the logging apparatus. Preferably, the transmission of the reference signal via the signal line occurs in parallel with the transmission of the reference signal to the logging apparatus.

In an additional form of embodiment of the method, the process variable is a temperature. Preferably of concern, in such case, is the temperature of the measured material used for calibrating the primary sensor.

As regards the apparatus, the object is achieved by an apparatus for determining a process variable, preferably for adjusting, calibrating and/or certification or validation of a primary sensor and comprises a primary sensor, which serves for producing an analog measurement signal representing a process variable, an analog to digital converter, which serves to convert the analog measurement signal into a digital signal representing the measured variable, at least one secondary sensor, which serves for producing at least one reference signal representing the process variable, wherein a control unit is provided, which is connected with the primary sensor and with the at least one secondary sensor, which control unit includes the analog to digital converter.

The control unit serves, as a function of the point in time, at which the reference signal displays the reaching of a predetermined state of the process variable, to log the value of the measurement signal of the primary sensor converted by means of the analog to digital converter. Furthermore, the control unit can serve, as a function of the point in time, at which the reaching of a predetermined state of the process variable is displayed by the reference signal, to interrupt the connection between the analog to digital converter and the primary sensor.

The control unit can serve, furthermore, as a function of the point in time, at which the reference signal displays the reaching of a predetermined state of the process variable, to change the sampling rate of the value of the measurement signal of the primary sensor converted by means of the analog to digital converter. The control unit can additionally serve, as a function of the point in time, at which the reaching of a predetermined state of the process variable is displayed by the reference signal, to change a processing in the evaluation unit, especially a measured value averaging, of the value of the measurement signal of the primary sensor converted by means of the analog to digital converter.

In an additional form of embodiment of the apparatus, the primary sensor is a sensor element for ascertaining a temperature.

In an additional form of embodiment of the apparatus, after completed conversion of the primary measurement signal, respectively storing of the primary measurement signal, the connection between primary sensor and analog to digital converter is reestablished.

In an additional form of embodiment of the apparatus, first and second secondary sensors are provided, as well as a circuit arrangement between the control unit and the first and second secondary sensors, wherein the circuit arrangement combines the reference signals respectively output by the first and second secondary sensors logically with one another and outputs a resulting reference signal to the control unit.

In an additional form of embodiment of the apparatus, a signal logging apparatus is provided, which is fed both the measurement signal of the primary sensor as well as also the at least one reference signal of the at least one secondary sensor. The signal logging apparatus can, in such case, be a component of the control unit. Preferably, in such case, the signal logging apparatus is fed on the input side the measurement signal of the primary sensor, respectively the at least one reference signal of the at least one reference sensor, respectively the resulting reference signal. On the output side, the signal logging apparatus can be connected with the analog to digital converter. The analog to digital converter is connected, in turn, with the evaluation unit. Besides transmission of the at least one reference signal to the control unit, respectively to the signal logging apparatus, signal transmission can occur via a signal line between the evaluation unit and the at least one secondary sensor.

In a form of embodiment of the proposed invention, in the evaluation unit (R1) an adjustment is performed based on a value pair formed by the reference signal by means of the primary sensor (M1) and the known transition point.

The invention will now be explained in greater detail based on the appended drawing, the figures of which show as follows:

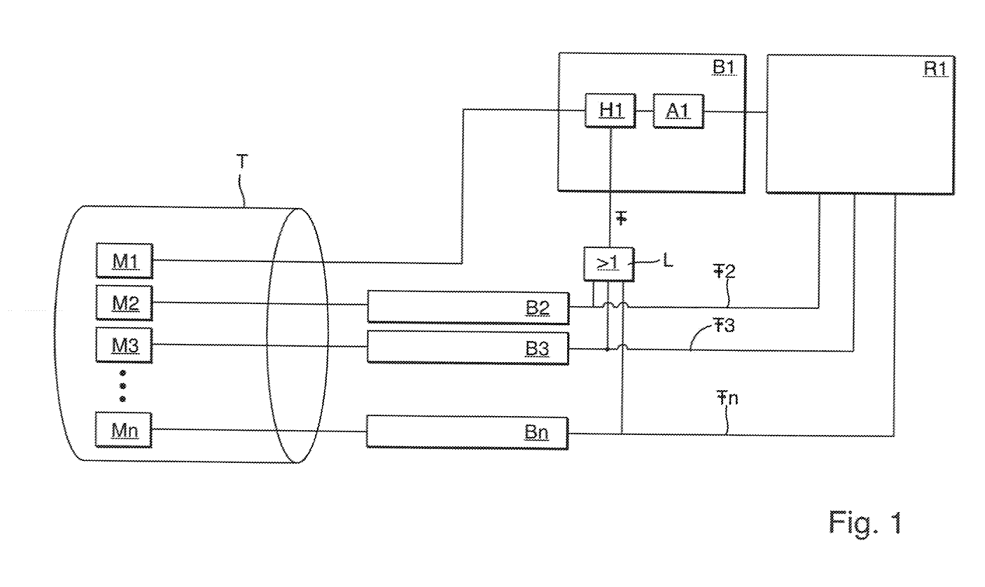

FIG. 1 a form of embodiment of the proposed invention.

FIG. 1 shows an arrangement comprising a number of sensors M1, M2, M3, Mn, wherein the sensor M1 is the so-called primary sensor, which is to be calibrated, validated, adjusted, certified or monitored in some other manner. To this end, there are provided in the example of an embodiment according to FIG. 1 a number of so-called secondary sensors M2, M3, Mn, which, preferably at the calibration point and especially preferably only at the calibration point, have a higher accuracy of measurement and especially also a higher long term stability than the primary sensor. Of course, also only exactly one secondary sensor with a higher accuracy of measurement than the primary sensor can be provided.

The sensors M1, M2, M3, Mn are, in such case, exposed in a process container F to a measured material and serve preferably to determine the temperature of the measured material. Alternatively or supplementally, the sensors M1, M2, M3, Mn can be arranged preferably together in a protective tube.

Sensor M1 delivers the actual measured variable for process monitoring. In addition to the actual measured variable M1 (e.g. temperature), sensors M2-Mn (e.g. bimetal switch or undergoing other process value dependent, state changes) are supplementally provided, which serve for registering further measured variables, such as, for example, likewise temperature or, however, also another measured variables. By means of the additional sensors M2-Mn, in each case, the reaching of a process point N2-Nn serving as a standard for the measured variable M1 can be ascertained.

On the one hand, the production of continuous measured values of the measured variable M1 following the course of the process with sufficient accuracy and measuring rate is pursued. Further pursued, on the other hand, is the production of exact as possible calibration values K2-Kn of the measured variable M1, when, at the points in time t2-tn, the process points N2-Nn serving as standards are reached. To this end, the measured variable M1 of a sensor is measured with additional, calibration information continuously by means of the measuring system B1 and evaluated by the calculating unit R1 (e.g. microcontroller). Located in the measuring system B1 are a sample and logging unit H1, which works in a continuous sampling mode and an AD converter A1, which converts the measured variable M1 continuously.

The measured variables M2-Mn are monitored by independent measuring systems B2-Bn optimized for the particular measured variables and standard values. As soon as the process reaches one of the standard points N at a point in time t, and this is recognized by the respective measuring system B, the sample, log unit Hi of the measuring system B1 is placed in the logging mode by means of the trigger signal T. The signal converted by the AD converter A1 is thus frozen at the point in time t and is then no longer dependent on the changeable, measured variable M1.

The trigger signal, which is a reference signal, can trigger the logging state of the sample, log member H1, respectively it can trigger the logging procedure. For example, a capacitor can be provided between the primary sensor M1 and the analog to digital converter, which is disconnected on the side facing the primary sensor by a switch, so that the last measurement signal output by the primary sensor M1 is logged by means of the capacitor (not shown).

Optionally, the AD converter A1 can also be placed in a more exact mode and/or the measured values supplementally filtered. In this way, a very exact calibration value K of the measured variable M1 correlated with the point in time t is produced. As soon as the calibration values K are present, the measuring system B1 returns to the continuous, sampling mode. An automatic adjustment can now be performed in the calculating unit R1 by means of the measured deviation of the calibration value K from the standard point N.

The corresponding trigger signal can be forwarded from the measuring system B1, respectively, in general, Bn, in the form of a trigger signal T1, respectively, in general, Tn, to the calculating unit R1, so that information is present in the calculating unit concerning by which secondary sensor the predetermined process state, i.e. the process state predetermined as a standard, was reached.

Additionally, the trigger signals T2, T3, respectively, in general, Tn, can be fed to a logic unit L, which combines the signals logically and outputs a corresponding, resulting trigger signal T. For example, the logic circuit can be a circuit, which gates the trigger signals with a logical OR.

### LIST OF REFERENCE CHARACTERS

M1 primary sensor
M2 first secondary sensor
M3 second secondary sensor
Mn nth secondary sensor
B1 first measuring system
B2 second measuring system
B3 third measuring system
Bn nth measuring system
M1 sample, log unit
A1 analog to digital converter (AD converter)
T resulting trigger signal
T2 second trigger signal
T3 third trigger signal
Tn nth device trigger signal
R1 calculating unit
F process container/protective tube

1-15. (canceled)

16. A method for determining a process variable, especially for validation, adjusting, calibrating and/or certification of a primary sensor comprising the steps of:
producing, by means of the primary sensor an analog measurement signal representing a process variable;
converting the analog measurement signal by means of an analog to digital converter into a digital signal representing the measured variable;
producing by means of at least one secondary sensor, at least one reference signal, representing the process variable, preferably a state of the process variable, such as, for example, a defined standard state; and
displaying the reference as a function of the point in time, at which the reaching of a predetermined state of the process variable, especially the reaching of a value of the reference signal itself, occurs wherein:
the value of the measurement signal of the primary sensor converted by means of the analog to digital converter is logged; and/or
the connection between the analog to digital converter and the primary sensor is interrupted; and/or
the sampling rate of the value of the measurement signal of the primary sensor converted by means of the analog to digital converter is changed; and/or
a processing, especially a measured value averaging, of the value of the measurement signal of the primary sensor converted by means of the analog to digital converter is changed in the evaluation unit.

17. The method as claimed in claim 16, wherein:
the measurement signal of the primary sensor is a continuous measurement signal.

18. The method as claimed in claim 16, wherein:
the reference signal is a discrete signal, preferably a signal that can be evaluated in a binary manner, or a discretely evaluatable signal, or a signal that exhibits a jump.

19. The method as claimed in claim 16, wherein:
an analog signal representing the process variable is ascertained by means of the secondary sensor; and
the process variable ascertained by means of the secondary sensor is converted into the reference signal by means of a measurement transmitter.

20. The method as claimed in claim 16, wherein:
the measurement signal and the at least one reference signal are fed to a signal logging apparatus, which is connected with, respectively includes, the analog to digital converter.

21. The method as claimed in claim 16, wherein:
the connection to the primary sensor can be produced and/or interrupted by means of the signal logging apparatus, preferably as a function of the reference signal.

22. The method as claimed in claim 16, wherein:
the digitized measurement signal representing the process variable is stored by means of an evaluation unit.

23. The method as claimed in claim 16, wherein:
the reaching of a predetermined state of the process variable is transmitted via a signal line between the at least one secondary sensor and the evaluation unit.

24. The method as claimed in claim 16, wherein:
the transmission of the reference signal via the signal line occurs in addition to, preferably parallel to, the transmission of the reference signal to the logging apparatus (H1).

25. The method as claimed in claim 16, wherein:
the process variable is a temperature.

26. An apparatus for determining a process variable, preferably for adjusting, calibrating and/or certification of a primary sensor, comprising:
a primary sensor, which serves for producing an analog measurement signal representing a process variable;
an analog to digital converter, which serves for converting the analog measurement signal into a digital signal representing the measured variable;
at least one secondary sensor, which serves for producing at least one reference signal representing the process variable; and
a control unit, which is connected with said primary sensor and said at least one secondary sensor,
which control unit includes said analog to digital converter and serves, as a function of the point in time, at which the reference signal displays the reaching of a predetermined state of the process variable, especially by reaching a value of the reference signal itself, to:
log the value of the measurement signal of said primary sensor converted by means of said analog to digital converter; and/or
interrupt the connection between said analog to digital converter and said primary sensor; and/or
change the sampling rate of the value of the measurement signal of said primary sensor converted by means of said analog to digital converter; and/or
change a processing in said evaluation unit, especially a measured value averaging, of the value of the measurement signal of said primary sensor converted by means of said analog to digital converter.

27. The apparatus as claimed in claim 26, wherein:
said primary sensor is a sensor element for ascertaining temperature.

28. The apparatus as claimed in claim 27, wherein:
after completed conversion of the primary measurement signal, respectively storing of the primary measurement signal, the connection between said primary sensor and an AD converter is reestablished.

29. The apparatus as claimed in claim 26, further comprising:
first and second secondary sensors are provided, as well as a circuit arrangement between said control unit and said first and second secondary sensors, wherein:
the circuit arrangement combines the reference signals output respectively by said first and second secondary sensors logically with one another and outputs a resulting reference signal to said control unit.

30. The apparatus as claimed in claim 29, wherein:
in said evaluation unit an adjustment is performed based on a value pair formed by the reference signal by means of said primary sensor and the known transition point.
